(19) United States
(12) Patent Application Publication
(10) Pub. No.: US 2022/0035820 A1
(43) Pub. Date: Feb. 3, 2022

(54) STORAGE STRUCTURE OF DATA OBJECT, METHOD AND SYSTEM FOR STORING AND DYNAMICALLY MANAGING DATA OBJECT ON COMPUTER, AND STORAGE MEDIUM AND ELECTRONIC DEVICE

(71) Applicants: PowerChina Huadong Engineering Corporation Limited, Hangzhou (CN); ZHEJIANG HUADONG ENGINEERING DIGITAL TECHNOLOGY CO., LTD., Hangzhou (CN)

(72) Inventors: Xiaoyong CHEN, Hangzhou (CN); Songqiang TANG, Hangzhou (CN); Yexing ZHANG, Hangzhou (CN); Guoguang WANG, Hangzhou (CN); Danpeng GU, Hangzhou (CN); Shuankang HE, Hangzhou (CN); Lingheng ZHU, Hangzhou (CN); Yuanxiang WU, Hangzhou (CN); Xuan ZHANG, Hangzhou (CN)

(21) Appl. No.: 17/503,530

(22) Filed: Oct. 18, 2021

(30) Foreign Application Priority Data
Jan. 13, 2021 (CN) 202110040159.6

(51) Int. Cl. G06F 16/2457; G06F 16/248; G06F 16/215; G06F 16/28; G06F 16/26

(52) U.S. Cl. CPC G06F 16/24573; G06F 16/248; G06F 16/26; G06F 16/284; G06F 16/215

(57) ABSTRACT

This application discloses a storage structure of a data object, a method and a system for storing and dynamically managing data objects on a computer, a storage medium and an electronic device. In the method, a data object template containing attribute tuples is constructed and stored, and then the data object template is read into the memory and the storage, update, query and deletion process of data objects is managed based on the data object template.

### CROSS-REFERENCE TO RELATED APPLICATIONS

This application claims the benefit of priority from Chinese Patent Application No. 202110040159.6, filed on Jan. 13, 2021. The content of the aforementioned application, including any intervening amendments thereto, is incorporated herein by reference in its entirety.

### TECHNICAL FIELD

The present application relates to data management, in particular to a storage structure of data objects, a method and system for storing and dynamically managing data objects on a computer, and a storage medium and an electronic device.

### BACKGROUND

In the data management field, it is often required to abstract data with the concept of objects at the application layer, assign the definition of the attribute information of the data objects based on the needs of users, and establish the relationship between the objects. The tables created based on a traditional relational database are all fixed attributes, and if the dynamic expansion and modification of attribute information under the concept of data objects need to be realized, it is required to additionally establish an intermediate table for the management of attribute information, and perform the mapping of the business layer. Considering that foreign keys and cascading updates are only suitable for single-machine low-concurrency clusters, and are not suitable for distributed, high-concurrency clusters; the cascading update is a strong block, so that there is a risk of database update storms; and the foreign keys affect the speed of database insertion, the foreign keys and cascades are no longer used in the relational databases to establish associations between tables.

With respect to the new NO-SQL database different from the relational database, the graph database shows new advantages in the case of managing the data as objects and emphasizing the relationship between the objects. The graph database focuses on the graph formed by the “association relationship”, and aims to store and analyze the association relationship between entities in the real world. Specifically, the entities are abstracted as vertices, and the association relationships between entities are abstracted as edges. The graph database intuitively and naturally expresses the world with all things connected through the graph structure formed by the vertices and edges and solves the performance problem existing in the deep retrieval of complex association relations at the same time. Generally, in the application of the graph database to manage the data objects in the form of graph structure, the attributes of the data objects themselves are generally embedded in the vertices in a fixed attribute field, while the relationship between objects is managed independently in the form of edges. In view of this, there is no unified dynamic management scheme for data objects and their attributes and association relationships.

Therefore, how to use the relational database to establish the attribute field mapping of the data object template, fully use the performance advantages of the graph database in the deep retrieval of the complex association relationship, and apply the graph database to the data application occasion where the data object association relationship is complex, and the attribute fields of the data object need to be changed has been a problem to be urgently solved for those skilled in the data management art.

### SUMMARY

An object of this application is to provide a method for storing and dynamically managing data objects on a computer based on the combination of the traditional relational database table structure and the graph structure database to overcome the defects in the prior art.

Technical solutions of this application are described as follows.

In a first aspect, this application provides a method for storing and dynamically managing data objects on a computer, comprising:

(S101) constructing and storing a data object template comprising an attribute tuple; and

(S102) reading a data object template into a memory, and managing storage, update, query and deletion of the data object based on the data object template.

In an embodiment, the step (S101) is performed through a step of:

constructing and storing a basic information and the attribute tuple of the data object template;

wherein the basic information of the data object template comprises a unique data object template identifier, a data object template name, a type of the data object and a data object template description information;

the attribute tuple comprises at least one attribute metadata;

each of the at least one attribute metadata comprises a unique attribute metadata identifier, a unique attribute metadata type, a unique attribute metadata name, a unique attribute metadata value rule, a unique attribute metadata default value and a unique attribute metadata description information; the attribute metadata type comprises a basic attribute metadata and a reference attribute metadata, where the basic attribute metadata is configured to define a basic data type comprising a text data, a numeric data and a time data; the reference attribute metadata is configured to define a reference association between data objects by associating an identifier of other data object templates, and define whether the reference association is a multiple reference association.

In an embodiment, the step (S102) is performed through a step of:

based on the basic attribute metadata and the reference attribute metadata defined by the data object template, operating a data object entity and a data object directed edge to complete creation, update and deletion of the data object;

the creation of the data object comprises:

creating the data object entity represented and stored by nodes of a computer graph and the data object directed edge represented and stored by directed edges of the computer graph based on the data object template constructed in step (S101), where the data object entity comprises a unique data object identifier and at least one key-value pair for storing basic attribute values, and the data object template identifier is used as a data object entity label; a key in each of the at least one key-value pair is an attribute metadata identifier of the basic attribute metadata; a value in each of the at least one key-value pair corresponds to an attribute value defined by the basic attribute metadata; the data object directed edge is configured to define a reference association between the data object entity and another data object entity through a label whose value is an attribute metadata identifier of a reference attribute metadata that defines the reference association, and when definition of the reference attribute metadata allows multiple reference associations, multiple data object directed edges that have the same label are established for the data object based on the same reference attribute metadata;

the update of the data object comprises:

updating the data object entity or the data object directed edge based on the data object template constructed in step (S101), where the data object entity is updated by updating a value of a key-value pair of the data object entity based on the basic attribute metadata contained in the data object template constructed in step (S101); and the data object directed edge is updated by updating a direction of the data object directed edge based on the reference attribute metadata contained in the data object template constructed in step (S101) or adding a data object directed edge that has the same label and points to other data object entities; and

the deletion of the data object comprises:

deleting the data object entity, the data object directed edge, and a data object directed edge which indicates that other data object entities point to a deleted data object entity.

In an embodiment, in step (S102), the update of the data object comprises:

adding a new attribute metadata to the attribute tuple of the data object template and adding a new attribute to the data object that has been created, where a value of the new attribute is an attribute metadata default value of the new attribute metadata;

updating an attribute name, an attribute value rule and an attribute metadata description information of an attribute metadata contained in the attribute tuple of the data object template, and updating an attribute of the data object;

deleting a basic attribute metadata contained in the attribute tuple of the data object template, a key-value pair contained in a data object entity and an attribute, where an internal key of the key-value pair is an attribute metadata identifier of the deleted basic attribute metadata; and

deleting a reference attribute metadata contained in the attribute tuple of the data object template, a data object directed edge and an attribute, where a label of the data object directed edge is an attribute metadata identifier of the deleted reference attribute metadata; and

the deletion of the data object comprises:

deleting the data object template and the data object.

In an embodiment, in the step (S102), the query of the data object is performed through a step of:

based on a basic attribute metadata and a reference attribute metadata defined by the data object template, operating a data object entity and a data object directed edge to realize the query of the data object;

the step of “operating a data object entity and a data object directed edge to realize the query of the data object” comprises:

based on a unique data object identifier, obtaining a data object entity that meets the data object unique identifier; based on a data object attribute value filtering condition, obtaining a data object entity that meets the data object attribute value filtering condition; and obtaining a query result through the data object entity and a data object directed edge associated with the data object entity;

in the step of “based on a data object attribute value filtering condition, obtaining a data object entity that meets the data object attribute value filtering condition”, when the data object attribute value filtering condition is an attribute corresponding to the basic attribute metadata, a data object entity that meets a filtering condition is obtained by subjecting key-value pairs contained in a data object entity to key-value filtering; and when the data object attribute filtering condition is an attribute corresponding to the reference attribute metadata, a data object entity that meets the filtering condition is obtained by filtering other data object entities pointed to by the data object directed edge; and

the query result obtained by a data object entity and a data object directed edge associated with a data object entity comprises a data object type and an attribute value list; the attribute value list consists of multiple attribute values matchedly read by an attribute metadata contained in the data object template, where when the attribute metadata contained in the data object template is the basic attribute metadata, an attribute metadata identifier of the basic attribute metadata is used to read a value of a key-value pair contained in the data object entity, and when there is no matching key-value pair, an attribute metadata default value of the basic attribute metadata is used as a read attribute value; when the attribute metadata contained in the data object template is the reference attribute, a data object directed edge using an attribute metadata identifier of the reference attribute metadata as a label is read, and when the reference attribute metadata defines that a multiple association is not allowed, a query result of the data object pointed to by the data object directed edge as a read attribute value, and when the reference attribute metadata defines that a multiple association is allowed, a list consisting of query results of multiple data objects pointed to by multiple data object directed edges as a read attribute value.

The present application also provides a storage structure of a data object, comprising: a data object template stored in a table structure; a data object entity; and a data object directed edge; where the data object entity and the data object directed edge are stored in a graph structure.

The present application also provides a system for storing and dynamically managing a data object on a computer, comprising:

a data object template management module; and

a data object dynamic management module;

where the data object template management module is configured to receive a data object template and create a description; the description describes a basic characteristic of a type of data and an attribute characteristic containing the basic characteristic, and is configured to construct the data object template comprising a unique data object template identifier, a data object template name, a data object type and a data object template description information, thereby creating and storing basic information and attribute tuples of the data object template;

the data object template management module is also configured to receive a data object template update instruction; the data object template update instruction describes an update of a basic information of a created data object template in the system or an update of an attribute tuple; and the data object template stored in the system is modified are based on the data object template update instruction; and the data object dynamic management module is configured to receive data creation, update, query, and deletion instructions to implement the step (S102).

The present application also provides a storage medium storing a computer program executable by a processor, where the computer program is executed by the processor to implement the method of storing and dynamically managing a data object on a computer.

The present application also provides an electronic device, comprising:

a processor; and

a storage medium which stores a computer program executable by the processor;

where the computer program is executed by the processor to implement the above-mentioned method of storing and dynamically managing a data object on a computer.

Compared to the prior art, this application has the following beneficial effects.

The disclosure employs a graph structure database to manage data objects and their association relations to replace the existing static attribute management with dynamic adjustment of data object attribute information (name, description). Compared with the method of statically storing the attribute key value of the data object with the nodes of the graph database, the method provided herein can greatly improve the efficiency of data update when the name and characteristics of the attribute need to be adjusted. In the prior art, the content of each data object is needed to be modified, while in the method of the disclosure, it is only required to directly modify the attribute metadata information of the data object template. In addition, data objects are stored in a graph structure, and the object association relationship is managed as a special attribute field at the same time, which can make full use of the performance advantages of the graph database in the deep retrieval of the complex association relationship. When querying a single data object and other data objects that have multi-layered indirect association with it, the retrieval time complexity is approximately linear. In the case of a large amount of data, compared to the multi-level join table query required by the table structure storage mode, the efficiency is improved significantly.

This solution is suitable for data applications where the association of data objects is complex and the attribute information of the data objects needs to be changed frequently, and can be used to build an object data management system that needs to create and adjust flexibly data objects at any time.

### BRIEF DESCRIPTION OF THE DRAWINGS

FIG. 1 is a flowchart of a method for storing and dynamically managing data objects on a computer according to an embodiment of the present application.

FIG. 2A-2B is a schematic diagram of a data object template according to an embodiment of the present application.

FIG. 3 schematically shows structure of a data object according to an embodiment of the present application.

FIG. 4 is a schematic diagram of data object entity and reference association according to an embodiment of the present application.

FIG. 5 schematically illustrates update results of the data object according to the embodiment of the present application.

FIG. 6 schematically depicts deletion results of the data object according to an embodiment of the present application.

FIG. 7A-7B schematically shows update of the data object by updating a data object template according to an embodiment of the present application.

FIG. 8A-8C schematically shows deletion of the data object by deleting a data object template according to an embodiment of the present application.

FIG. 9 is a schematic diagram of data object query according to an embodiment of the present application.

FIG. 10 is another schematic diagram of the data object query according to an embodiment of the present application.

### DETAILED DESCRIPTION OF EMBODIMENTS

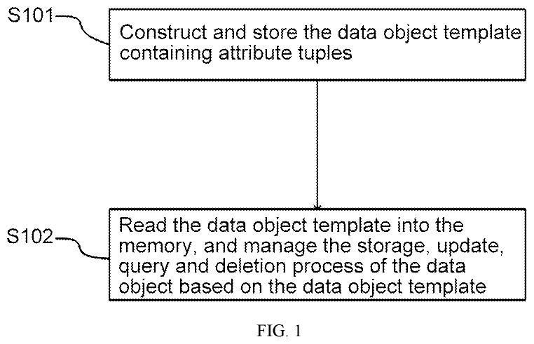

Referring to FIG. 1, this embodiment provides a method for storing and dynamically managing data objects on a computer, which includes the following steps.

(S101) A data object template including an attribute tuple is constructed and stored.

In the step (S101), a basic information and the attribute tuple of the data object template are constructed and stored, where:

(1) the basic information of the data object template includes a unique data object template identifier, a data object template name, a type of the data object and a data object template description information;

(2) the attribute tuple includes at least one attribute metadata;

(3) each of the at least one attribute metadata includes a unique attribute metadata identifier, a unique attribute metadata type, a unique attribute metadata name, a unique attribute metadata value rule, a unique attribute metadata default value and a unique attribute metadata description information; the attribute metadata type includes a basic attribute metadata and a reference attribute metadata, where the basic attribute metadata is configured to define a basic data type including a text data, a numeric data and a time data; the reference attribute metadata is configured to define a reference association between data objects by associating an identifier of other data object templates, and define whether the reference association is a multiple reference association.

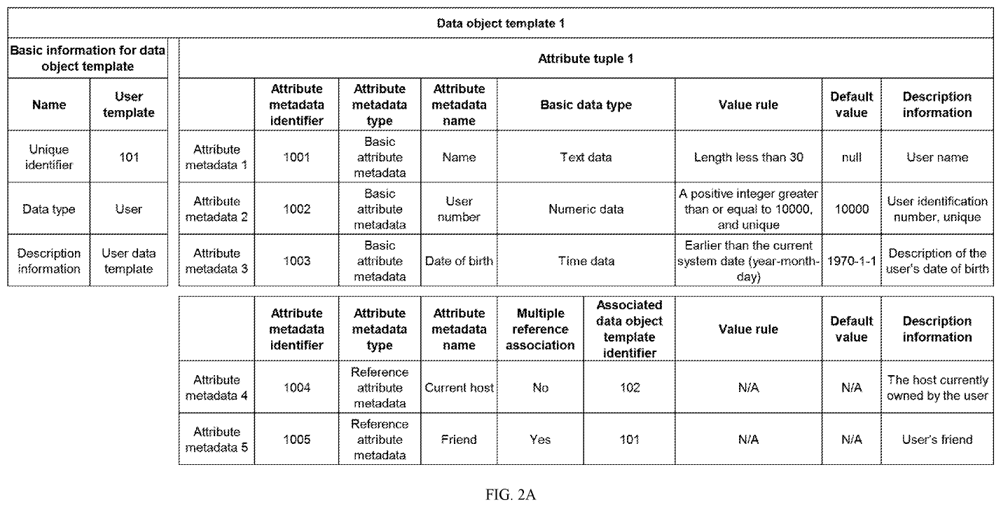

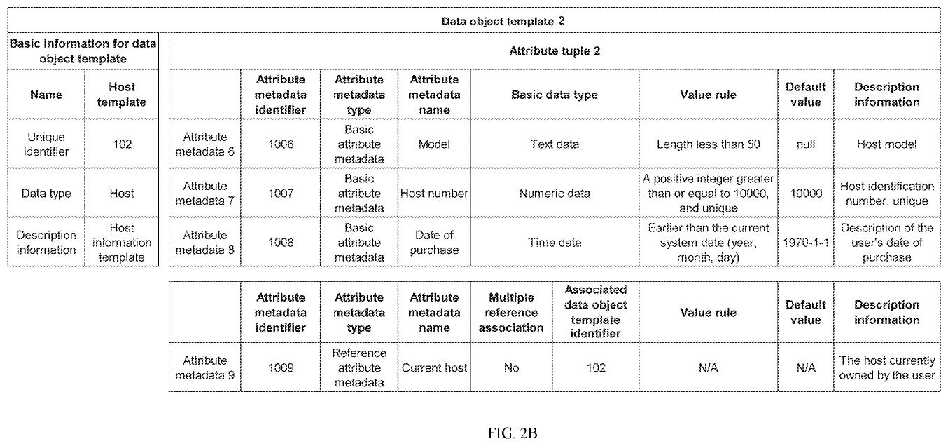

Referring to FIG. 2, in this embodiment, relevant professionals put forward some specific requirements for the data object management. Based on these requirements, the data object template is constructed and stored, which includes the construction and storage of the basic information and attribute tuples of the data object template. This embodiment constructs and stores two data object templates, respectively a user template (identified as 101) and a host template (identified as 102), each containing an attribute tuple.

1. The attribute tuple of the user template contains 5 attribute metadatas, which are described as follows.

(1) Attribute metadata identifier: 1001; type of the attribute metadata: basic attribute metadata; basic data type of the basic attribute metadata: text data; attribute metadata name: name; attribute metadata value rule: length less than 30; attribute metadata default value: null; and description information: user name.

(2) Attribute metadata identifier: 1002; type of the attribute metadata: basic attribute metadata; basic data type of the attribute metadata: numeric data; attribute metadata name: user number; attribute metadata value rule: a positive integer greater than or equal to 10000, which is unique; attribute metadata default value: 10000; attribute metadata description information: user identifier number, which is a unique.

(3) Attribute metadata identifier: 1003; type of the attribute metadata: basic attribute metadata; basic data type of the basic attribute metadata: time data; attribute metadata name: the date of birth; attribute metadata value rule: the date is earlier than the current system date; attribute metadata default value: 1970-01-01.attribute metadata description information: the description of the user's date of birth.

(4) Attribute metadata identifier: 1004; type of the attribute metadata: reference attribute metadata; attribute metadata name: current host; attribute metadata value rule: N/A; attribute metadata default value: N/A. attribute metadata description information: the host currently owned by the user; multiple reference association: no; the associated data object template identifier: 102.

(5) Attribute metadata identifier: 1005; type of the attribute metadata: reference attribute metadata; attribute metadata name: friend; attribute metadata value rule: N/A; attribute metadata default value: N/A; attribute metadata description information: the user's friend; multiple reference association: yes; the associated data object template identifier: 101.

2. The attribute tuple of the host template contains 4 attribute metadatas, which are described as follows.

(1) Attribute metadata identifier: 1006; type of the attribute metadata: basic attribute metadata; data type of the basic attribute metadata: text data; attribute metadata name: model; attribute metadata value rule: the length is less than 50; attribute metadata default value: null; data metadata description information: the host model.

(2) Attribute metadata identifier is 1007; type of the attribute metadata: basic attribute metadata; data type of the basic attribute metadata: numeric data; attribute metadata name: host number; attribute metadata value rule: a positive integer greater than or equal to 10000, which is unique; attribute metadata default value: 10000; attribute metadata description information: host identifier number, which is a unique.

(3) Attribute metadata identifier: 1008; type of the attribute metadata: basic attribute metadata; data type of the basic attribute metadata: time data; attribute metadata name: the purchase date; attribute metadata value rule: the date is earlier than the current system date; attribute metadata default value: 1970-01-01; attribute metadata description information: the description of the purchase date of the host.

(4) Attribute metadata identifier: 1009; type of the attribute metadata: reference attribute metadata; attribute metadata name: the adjacent host; attribute metadata value rule: N/A; attribute metadata default value: N/A; attribute metadata description information: the host adjacent to the current host; multiple reference association: yes; the associated data object template identifier: 102.

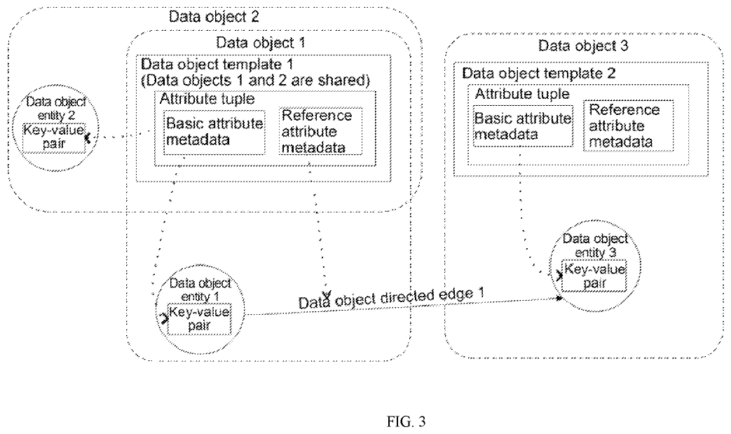

Referring to FIG. 3, a structure of a data object is provided, which includes a data object template stored in a table structure created in step (S101), and a data object entity and a data object directed edge stored in a graph structure. The data object templates can be shared by multiple data objects.

(S102) a data object template is read into a memory, and the storage, update, query and deletion of the data object are managed based on the data object template.

The data object management is performed based on the data object template. Specifically, based on the basic attribute metadata and the reference attribute metadata defined by the data object template, the creation, update, and deletion of the data object are implemented by operating the data object entity and the directed edge of the data object.

The creation of the data object includes the creation of the data object entity represented and stored by nodes of a computer graph and the data object directed edge represented and stored by directed edges of the computer graph based on the data object template constructed and stored in step (S101), where the data object entity includes a unique data object identifier and at least one key-value pair for storing basic attribute values, and the data object template identifier is used as a data object entity label; a key in each of the at least one key-value pair is an attribute metadata identifier of the basic attribute metadata; a value in each of the at least one key-value pair corresponds to an attribute value defined by the basic attribute metadata; the data object directed edge is configured to define a reference association between the data object entity and another data object entity through a label whose value is an attribute metadata identifier of a reference attribute metadata that defines the reference association, and when definition of the reference attribute metadata allows multiple reference associations, multiple data object directed edges that have the same label can be established for the data object based on the same reference attribute metadata.

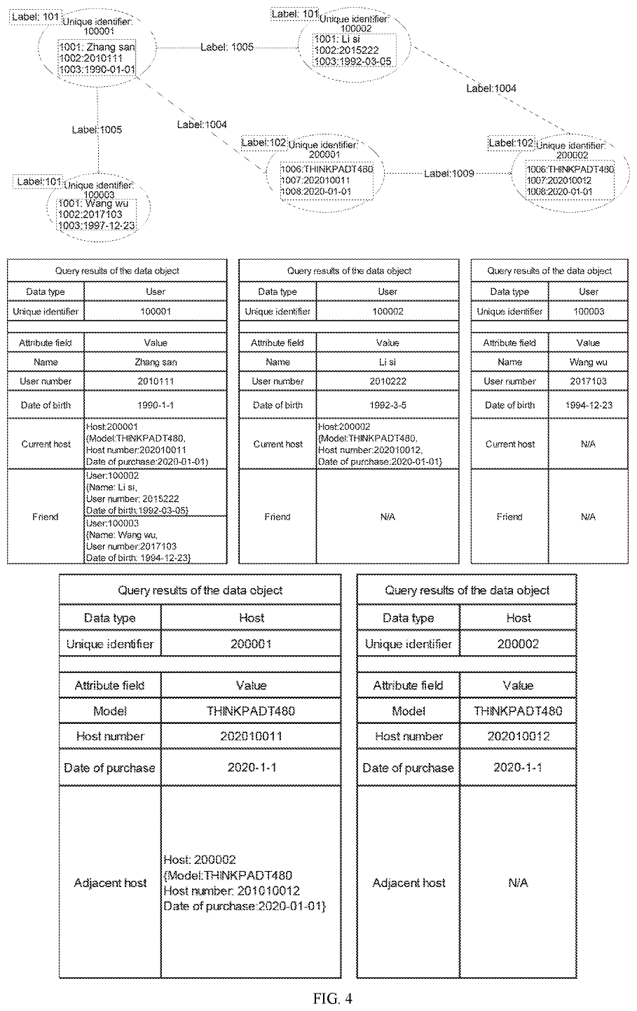

Referring to an embodiment illustrated in FIG. 4, five data objects are created, which are listed as follows.

(1) Data object unique identifier: 100001, data object entity label: 101, data object entity: {1001: Zhang San, 1002: 2010111, 1003: 1990-01-01}, data object directed edges: carrying label 1005 and pointing from the data object entity with a data object unique identifier of 100001 to the data object entity with a data object unique identifier of 100002, carrying the label 1005 and pointing from the data object entity with a data object unique identifier of 100001 to the data object entity with a data object unique identifier of 100003, and carrying the label 1004 and pointing from the data object entity with a data object unique identifier of 100001 to the data object entity with a data object unique identifier of 200001.

(2) Data object unique identifier: 100002, data object entity label: 101, data object entity: {1001: Li Si, 1002: 2015222, 1003: 1992-03-05}, data object directed edge: carrying the label 1004 and pointing from the data object entity with a data object unique identifier of 100002 to the data object entity with a data object unique identifier of 200002.

(3) Data object unique identifier: 100003, data object entity label: 101, data object entity: {1001: Wang Wu, 1002: 2017103, 1003: 1994-12-23}.

(4) Data object unique identifier: 200001, data object entity label: 102, data object entity: {1006: THINKPADT480, 1007: 202010011, 1008: 2020-01-01}, data object directed edge: carrying label 1009 and pointing from the data object entity with a data object unique identifier of 200001 to the data object entity with a data object unique identifier of 200002.

(5) Data object unique identifier: 200002, data object entity label: 102, data object entity: {1006: THINKPADT480, 1007: 202010012, 1008: 2020-01-01}.

The update of the data object includes the update of the data object entity or the data object directed edge based on the data object template constructed in step (S101), where the data object entity is updated by updating a value of a key-value pair of the data object entity based on the basic attribute metadata contained in the data object template constructed in step (S101), and the data object directed edge is updated by updating a direction of the data object directed edge based on the reference attribute metadata contained in the data object template constructed in step (S101) or a data object directed edge that has the same label and points to other data object entities is added.

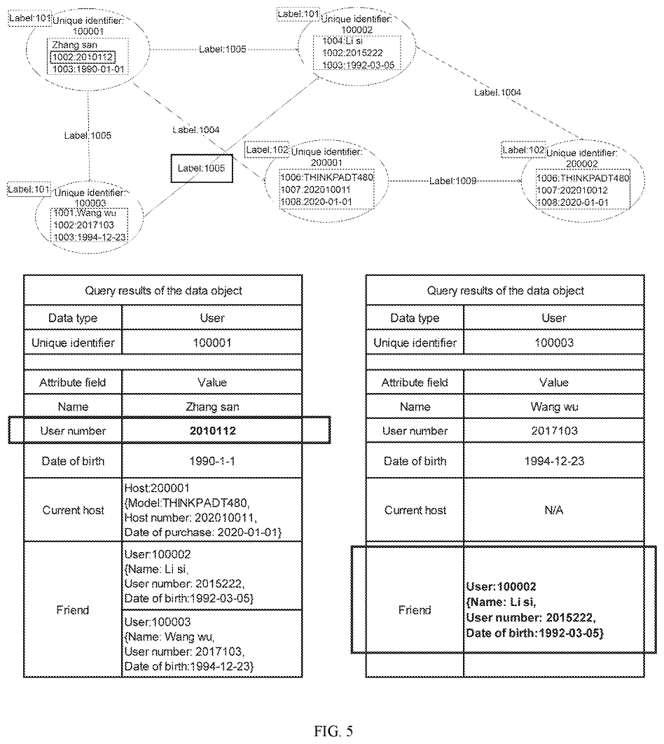

Referring to FIG. 5, two data objects are updated. Specifically, the data object entity of the data object (unique data object identifier: 100001) is updated by updating the value of the key-value pair (“2010111” is updated to “2010112”) of the data object entity based on the basic attribute metadata (attribute metadata identifier: 1002) contained in the data object template (data object template identifier: 101) constructed and stored in step (S101); and the data object directed edge of the data object (unique data object identifier: 100003) is updated by adding a new label 1005 pointing to the data object entity with the unique data object identifier of 100002 based on the data object template (data object template identifier: 101) constructed and stored in step (S101).

The deletion of the data object includes that the data object entity, the data object directed edges, and other data object directed edges which indicates that other data object entities point to a deleted data object entity are deleted.

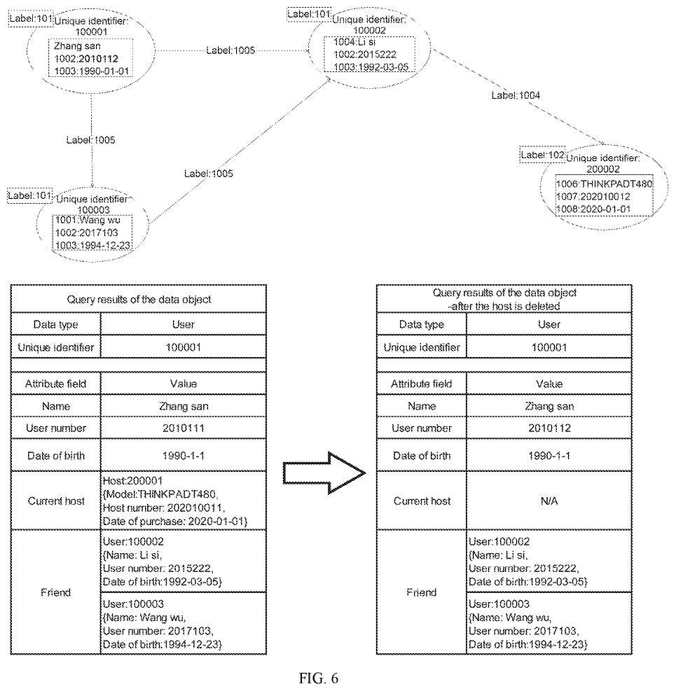

Referring to FIG. 6, the data object with a unique data object identifier of 200001 is deleted. Specifically, the data object entity, the data object directed edge pointing from the data object entity with a unique data object identifier of 200001 and the label 1009 to the data object entity with a unique data object identifier of 200002 and the data object directed edge pointing from the data object entity with a unique data object identifier of 100001 and the label 1004 to the data object entity with a unique data object identifier of 200001 are deleted.

The step (S102) includes updating and deleting the data object by modifying the data object template.

(1) The update of the data object is performed as follows.

A new attribute metadata is added to the attribute tuple of the data object template, and a new attribute is added to the created data object, where the value of the newly-added attribute is the default value of the added attribute metadata.

The attribute metadata name, the attribute value rule and the attribute metadata description information contained in the attribute tuple of the data object template are updated, and the attribute of the data object is also updated.

The basic attribute metadata contained in the attribute tuple of the data object template, the key-value pair whose internal key is the attribute metadata identifier of the deleted basic attribute metadata and the attribute are deleted.

The reference attribute metadata contained in the attribute tuple of the data object template, the data object directed edge of the data object with a label being the attribute metadata identifier of the deleted reference attribute metadata and the attribute are deleted.

(1) The deletion of the data object includes deletion of the data object template and data object.

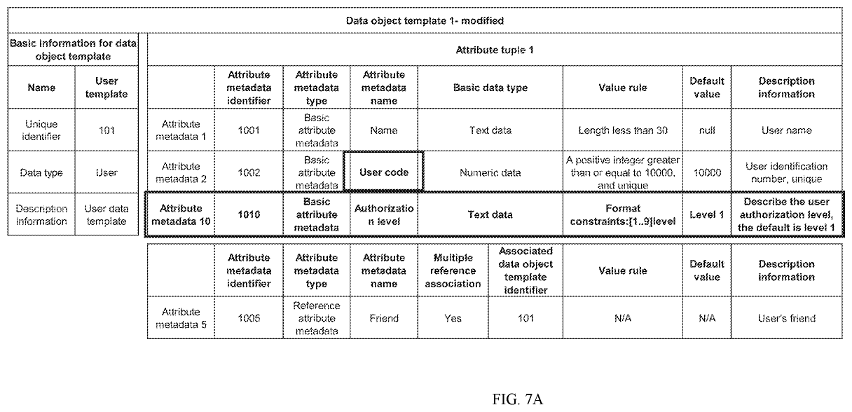

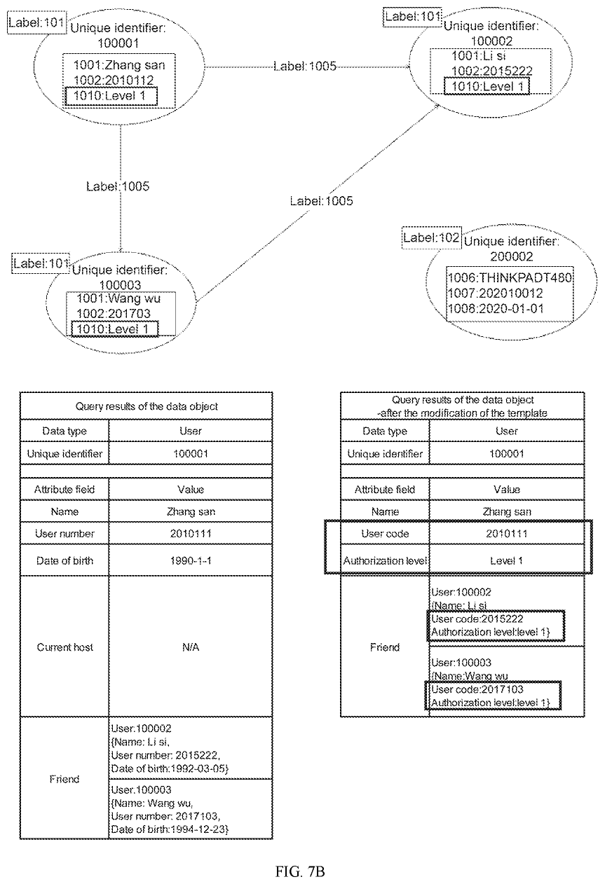

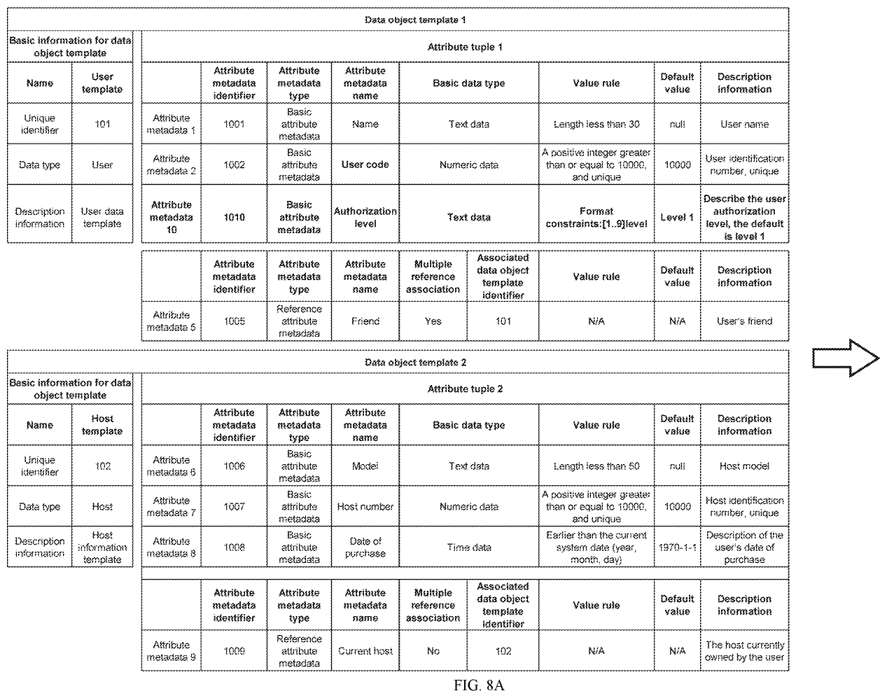

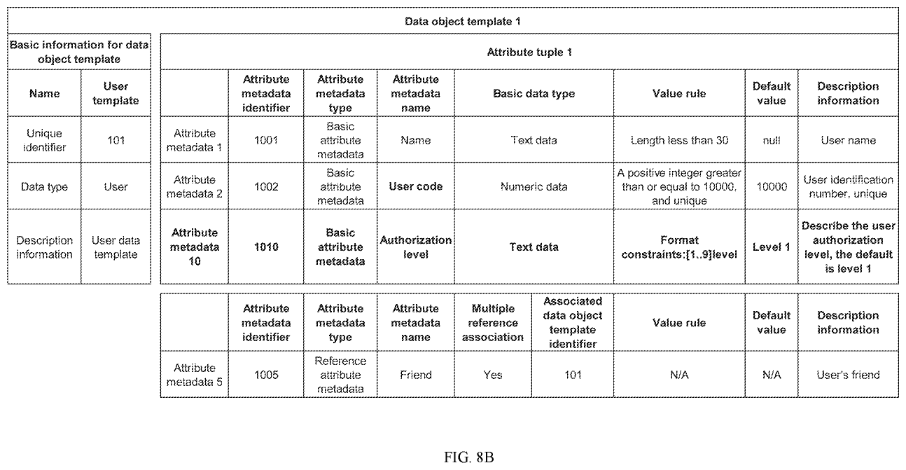

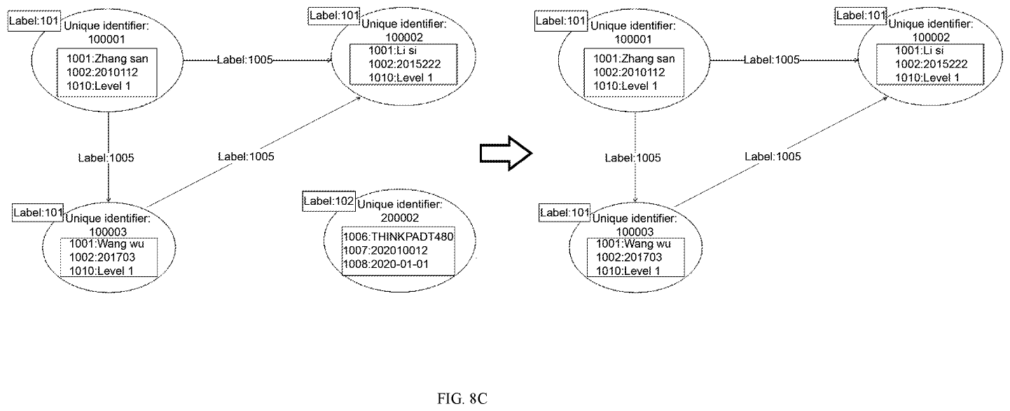

Referring to an embodiment shown in FIG. 7, the attribute name of the attribute metadata of the user template of the data object template whose attribute metadata identifier is 1002 is modified. In this modification, the “User Number” is changed to “User Code”. The attribute metadata with the identifier of 1010 (attribute metadata identifier: 1010, attribute metadata type: basic attribute metadata, basic data type of basic attribute metadata: text data, attribute metadata name: authorization level, attribute metadata value rules: the format is restricted to levels 1-9, the attribute default value: level 1, the attribute metadata description information: describes the user authorization level, the default level is 1.) is added. The basic attribute metadata with the unique identifier 1003 is deleted, and the reference attribute metadata with the unique identifier 1004 is deleted. After the data object is updated, referring to FIG. 8, the “User ID” is modified to “User Code”, the “Date of Birth” attribute is removed, and the “Authorization Level” attribute is added in the attribute value list. The value is the default value “level 1”. In the value list of the “friend” attribute, the attribute of each user is updated accordingly.

When the data object is deleted, the data object template is deleted and the data object is deleted at the same time.

In an embodiment, referring to FIG. 8, the data object template (data object template identifier: 102) is deleted, and the data object (data object unique identifier: 200002) is deleted at the same time.

In the step (S102), the query of the data object is performed through a step of: based on a basic attribute metadata and a reference attribute metadata defined by the data object template, a data object entity and a data object directed edge are operated to realize the query of the data object.

The step of “a data object entity and a data object directed edge are operated to realize the query of the data object” includes that based on a unique data object identifier, a data object entity that meets the data object unique identifier is obtained and based on a data object attribute value filtering condition, a data object entity that meets the data object attribute value filtering condition is obtained. The query result is obtained through the data object entity and a data object directed edge associated with the data object entity;

(1) Based on a data object attribute value filtering condition, the data object entity that meets the data object attribute value filtering condition is obtained. When the data object attribute value filtering condition is an attribute corresponding to the basic attribute metadata, a data object entity that meets a filtering condition is obtained by subjecting key-value pairs contained in a data object entity to key-value filtering. When the data object attribute filtering condition is an attribute corresponding to the reference attribute metadata, a data object entity that meets the filtering condition is obtained by filtering other data object entities pointed to by the data object directed edge.

(2) The query result obtained by a data object entity and a data object directed edge associated with a data object entity includes a data object type and an attribute value list. The attribute value list consists of multiple attribute values matchedly read by an attribute metadata contained in the data object template. When the attribute metadata contained in the data object template is the basic attribute metadata, an attribute metadata identifier of the basic attribute metadata is used to read a value of a key-value pair contained in the data object entity and when there is no matching key-value pair, an attribute metadata default value of the basic attribute metadata is used as a read attribute value. When the attribute metadata contained in the data object template is the reference attribute, a data object directed edge using an attribute metadata identifier of the reference attribute metadata as a label is read, and when the reference attribute metadata defines that a multiple association is not allowed, a query result of the data object pointed to by the data object directed edge as a read attribute value, and when the reference attribute metadata defines that a multiple association is allowed, a list consisting of query results of multiple data objects pointed to by multiple data object directed edges as a read attribute value.

In this embodiment, two data object queries are implemented as follows.

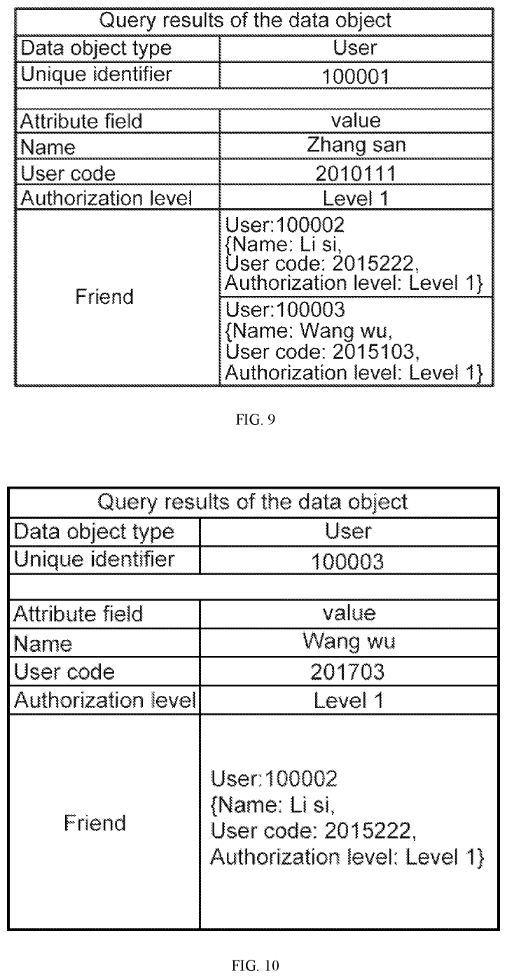

1. The data object entity conforming to the unique identifier of the data object is obtained, based on which the query result through the data object entity and the data object directed edge associated with the data object entity is obtained. The query results specifically includes querying the data object based on the data object unique identifier of 100001 and querying the data object entity and the directed edge of the data object associated with the data object entity according to the data object unique identifier, and based on the data object template constructed and stored in S101 and the attribute tuples included therein, a data object query result is parsed, including a data object type and attribute value list. The query result is shown in FIG. 9.

2. The data object entity that meets the data object attribute value filter condition is obtained based on the data object attribute value filter condition and the query result through the data object entity and the data object directed edge associated with the data object entity the query result is obtained. The query results specifically includes that based the filtering conditions based on the attribute value of the data object “based on the basic attribute metadata that uses 1002 as the attribute metadata identifier, ‘user code’ as a attribute metadata name, and its basic data type as numeric data, and ‘Greater than 2017000’” is set as the filtering condition”, the unique identifier of the filtered data object is 100003 and according to the data object unique identifier, the data object entity and the data object directed edge associated with the data object entity are respectively queried, and based on the data object template constructed and stored in S101 and the attribute tuples included, the data object query result is parsed, which contains data object types and a list of attribute values, see FIG. 10.

In some embodiments, a data object storage structure comprises data object templates stored in a table structure, and data object entities and data object directed edges stored in a graph structure.

In some embodiments, a system for storing and dynamically managing data objects on a computer includes a first data object template management module and a second data object dynamic management module. The first data object template management module is used to receive data object templates and create instruction. The instruction describes the basic characteristics of a type of data and the attribute characteristics containing the basic characteristics. It is used to construct a data object template, including a unique data object template identifier, data object template name, adapted data object type, data object template description information, thereby creating and storing basic information and attribute tuples of the data object template.

The first data object template management module is also used to receive data object template update instructions, which describe the basic information update or attribute tuple update of the data object templates that have been created in the system, and modify the stored data object templates according to the instructions.

The second data object dynamic management module is used to receive data creation, update, query, instruction deletion. It also implements the S102 that the data object template is read into the memory and the storage, update, query, and deletion process of the data object is managed based on the data object template.

In some embodiments, a storage medium stores a computer program that can be executed by a processor. When the computer program is executed, the method for storing and dynamically managing data objects on a computer is implemented.

In some embodiments, an electronic device is equipped with a processor and a storage medium, and the storage medium stores a computer program that can be executed by the processor. When the computer program is executed by the processor, the method for storing and dynamically managing data objects in a computer is implemented.

Described above are merely preferred embodiments of the disclosure, which are not intended to limit the disclosure. Any changes, modifications, replacements and variations made by those of ordinary skills in the art without departing from the spirit of the disclosure shall fall within the scope of the disclosure defined by the appended claims.

What is claimed is:

1. A method for storing and dynamically managing a data object on a computer, comprising:
(S101) constructing and storing a data object template comprising an attribute tuple; and
(S102) reading a data object template into a memory, and managing storage, update, query and deletion of the data object based on the data object template.

2. The method of claim 1, wherein the step (S101) is performed through a step of:
constructing and storing a basic information and the attribute tuple of the data object template;
the basic information of the data object template comprises a unique data object template identifier, a data object template name, a type of the data object and a data object template description information;
the attribute tuple comprises at least one attribute metadata;
each of the at least one attribute metadata comprises a unique attribute metadata identifier, a unique attribute metadata type, a unique attribute metadata name, a unique attribute metadata value rule, a unique attribute metadata default value and a unique attribute metadata description information; the attribute metadata type comprises a basic attribute metadata and a reference attribute metadata, wherein the basic attribute metadata is configured to define a basic data type comprising a text data, a numeric data and a time data; the reference attribute metadata is configured to define a reference association between data objects by associating an identifier of other data object templates, and define whether the reference association is a multiple reference association.

3. The method of claim 1, wherein the step (S102) is perform through a step of:
based on a basic attribute metadata and a reference attribute metadata defined by the data object template, operating a data object entity and a data object directed edge to complete creation, update and deletion of the data object;
the creation of the data object comprises:
creating the data object entity represented and stored by nodes of a computer graph and the data object directed edge represented and stored by directed edges of the computer graph based on the data object template constructed in step (S101);
wherein the data object entity comprises a unique data object identifier and at least one key-value pair for storing basic attribute values, and the data object template identifier is used as a data object entity label; a key in each of the at least one key-value pair is an attribute metadata identifier of the basic attribute metadata; a value in each of the at least one key-value pair corresponds to an attribute value defined by the basic attribute metadata; the data object directed edge is configured to define a reference association between the data object entity and another data object entity through a label whose value is an attribute metadata identifier of a reference attribute metadata that defines the reference association, and when definition of the reference attribute metadata allows multiple reference associations, multiple data object directed edges that have the same label are established for the data object based on the same reference attribute metadata;
the update of the data object comprises:
updating the data object entity or the data object directed edge based on the data object template constructed in step (S101); wherein the data object entity is updated by updating a value of a key-value pair of the data object entity based on the basic attribute metadata contained in the data object template constructed in step (S101); and the data object directed edge is updated by updating a direction of the data object directed edge based on the reference attribute metadata contained in the data object template constructed in step (S101) or adding a data object directed edge that has the same label and points to other data object entities; and
the deletion of the data object comprises:
deleting the data object entity, the data object directed edge, and a data object directed edge which indicates that other data object entities point to a deleted data object entity.

4. The method of claim 1, wherein in step (S102), the update of the data object comprises:
adding a new attribute metadata to the attribute tuple of the data object template and adding a new attribute to the data object that has been created, wherein a value of the new attribute is an attribute metadata default value of the new attribute metadata;
updating an attribute name, an attribute value rule and an attribute metadata description information of an attribute metadata contained in the attribute tuple of the data object template, and updating an attribute of the data object;
deleting a basic attribute metadata contained in the attribute tuple of the data object template, a key-value pair contained in a data object entity and an attribute of the data object, wherein an internal key of the key-value pair is an attribute metadata identifier of the deleted basic attribute metadata; and
deleting a reference attribute metadata contained in the attribute tuple of the data object template, a data object directed edge and an attribute of another data object, wherein a label of the data object directed edge is an attribute metadata identifier of the deleted reference attribute metadata; and
the deletion of the data object comprises:
deleting the data object template and the data object.

5. The method of claim 1, wherein in the step (S102), the query of the data object is performed through a step of:
based on a basic attribute metadata and a reference attribute metadata defined by the data object template, operating a data object entity and a data object directed edge to realize the query of the data object;
the step of “operating a data object entity and a data object directed edge to realize the query of the data object” comprises:
based on a unique data object identifier, obtaining a data object entity that meets the data object unique identifier; or based on a data object attribute value filtering condition, obtaining a data object entity that meets the data object attribute value filtering condition; and obtaining a query result through the data object entity and a data object directed edge associated with the data object entity;
in the step of “based on a data object attribute value filtering condition, obtaining a data object entity that meets the data object attribute value filtering condition”, when the data object attribute value filtering condition is an attribute corresponding to the basic attribute metadata, a data object entity that meets a filtering condition is obtained by subjecting key-value pairs contained in a data object entity to key-value filtering; and when the data object attribute filtering condition is an attribute corresponding to the reference attribute metadata, a data object entity that meets the filtering condition is obtained by filtering other data object entities pointed to by the data object directed edge; and
the query result obtained by a data object entity and a data object directed edge associated with a data object entity comprises a data object type and an attribute value list; the attribute value list consists of multiple attribute values matchedly read by an attribute metadata contained in the data object template, wherein when the attribute metadata contained in the data object template is the basic attribute metadata, an attribute metadata identifier of the basic attribute metadata is used to read a value of a key-value pair contained in the data object entity, and when there is no matching key-value pair, an attribute metadata default value of the basic attribute metadata is used as a read attribute value; when the attribute metadata contained in the data object template is the reference attribute, a data object directed edge using an attribute metadata identifier of the reference attribute metadata as a label is read, and when the reference attribute metadata defines that a multiple association is not allowed, a query result of the data object pointed to by the data object directed edge as a read attribute value, and when the reference attribute metadata defines that a multiple association is allowed, a list consisting of query results of multiple data objects pointed to by multiple data object directed edges as a read attribute value.

6. A storage structure of a data object, comprising:
a data object template stored in a table structure;
a data object entity; and
a data object directed edge;
wherein the data object entity and the data object directed edge are stored in a graph structure.

7. A system for storing and dynamically managing a data object on a computer, comprising:
a data object template management module; and
a data object dynamic management module;
wherein the data object template management module is configured to receive a data object template and create a description; the description describes a basic characteristic of a type of data and an attribute characteristic containing the basic characteristic, and is configured to construct the data object template comprising a unique data object template identifier, a data object template name, a data object type and a data object template description information, thereby creating and storing basic information and attribute tuples of the data object template;
the data object template management module is also configured to receive a data object template update instruction; the data object template update instruction describes an update of a basic information of the data object template in the system or an update of an attribute tuple; and the data object template stored in the system is modified are based on the data object template update instruction; and
the data object dynamic management module is configured to receive data creation, update, query, and deletion instructions to implement the step (S102) in the method of claim 1.

8. A storage medium storing a computer program executable by a processor, wherein the computer program is executed by the processor to implement the method of claim 1.

9. An electronic device, comprising:
a processor; and
a storage medium which stores a computer program executable by the processor;
wherein the computer program is executed by the processor to implement the method of claim 1.
